(19) United States
(12) Patent Application Publication
(10) Pub. No.: US 2009/0323800 A1
(43) Pub. Date: Dec. 31, 2009

(54) MULTIMEDIA CODEC DEVICE AND METHOD THEREOF

(76) Inventor: Yu-Hsia HSIAO, Taipei Hsien (TW)

Correspondence Address: Muncy, Geissler, Olds & Lowe, PLLC, P.O. BOX 1364, FAIRFAX, VA, 22038-1364, US

(21) Appl. No.: 12/467,811

(22) Filed: May 18, 2009

(30) Foreign Application Priority Data
Jun. 25, 2008 (TW) 97123776

(51) Int. Cl. H04N 11/02

(52) U.S. Cl. 375/240.01; 375/E07.026

(57) ABSTRACT

A multimedia codec device includes a codec bridge, a source filter, a transformation filter and a rendering filter. The codec bridge is a plug-in of a first multimedia interface. The source filter, the transformation filter and the rendering filter are disposed in a second multimedia interface. The codec bridge sends a first multimedia data to the second multimedia interface. The source filter receives the first multimedia data. The transformation filter transforms the first multimedia data into a second multimedia data according to a codec package compatible with the second multimedia interface. Therefore, the second multimedia data can be compatible with the first multimedia interface. The rendering filter outputs the second multimedia data to the codec bridge.

### RELATED APPLICATIONS

This application claims priority to Taiwan Application Serial Number 97123776, filed Jun. 25, 2008, which is herein incorporated by reference.

### BACKGROUND OF THE INVENTION

1. Field of the Invention

The present invention relates to multimedia codec devices and methods thereof, and more particularly, to a multimedia codec device using multiple multimedia interfaces and a method thereof.

2. Description of the Prior Art

With multimedia file formats being ever-changing, most multimedia interface developers have to write a codec program independently and enable the codec program to be a plug-in of a multimedia interface in order to allow the multimedia interface to expand support for multimedia file formats. The aforesaid process is inconvenient and time-consuming.

However, not all latest multimedia file formats require a new codec program. The developers always write, in the course of the launching of various multimedia file formats, a codec program with respect to a specific multimedia interface.

Hence, there is a need for a multimedia codec device and method whereby a multimedia file format not supported by a multimedia interface can be processed by other multimedia interface, so developers need not write a codec program independently for processing the otherwise unsupported multimedia file format.

### SUMMARY OF THE INVENTION

It is an objective of the present invention to provide a multimedia codec device whereby a multimedia interface's capacity to process multimedia is expanded by another multimedia interface, such that a developer of the former multimedia interface is no longer hampered in its efforts by a multimedia file format supported by the former multimedia interface.

In a preferred embodiment of the present invention, a multimedia codec device comprises a codec bridge, a source filter, a transformation filter, and a rendering filter. The codec bridge is a plug-in of a first multimedia interface. The source filter, the transformation filter and the rendering filter are disposed in a second multimedia interface. The codec bridge sends a first multimedia data to the second multimedia interface. The source filter receives the first multimedia data. The transformation filter transforms the first multimedia data into a second multimedia data according to a codec package compatible with the second multimedia interface, allowing the second multimedia data to be compatible with the first multimedia interface. The rendering filter outputs the second multimedia data to the codec bridge.

In another preferred embodiment of the present invention, a multimedia codec method comprises the steps of:

(1) receiving a first multimedia data from a first multimedia interface to a second multimedia interface;

(2) transforming the first multimedia data into a second multimedia data according to a codec package compatible with the second multimedia interface, so as to allow the second multimedia data to be compatible with the first multimedia interface; and

(3) outputting the second multimedia data to the first multimedia interface.

### BRIEF DESCRIPTION OF THE DRAWINGS

The above described and other objectives, features, advantages, and embodiments of the invention will be best understood by referring to the following detailed description of the accompanying drawings, wherein:

FIG. 1 depicts a block diagram of a multimedia codec device according to a preferred embodiment of the present invention;

FIG. 2 depicts a block diagram of a codec bridge according to the preferred embodiment of the present invention;

FIG. 3 depicts a block diagram of a transformation filter according to the preferred embodiment of the present invention;

FIG. 4 depicts a flow chart of a multimedia codec method according to another preferred embodiment of the present invention;

FIG. 5 depicts a flow chart of a method for acquiring an input format according to the present invention;

FIG. 6 depicts a flow chart of a method for acquiring an output format according to the present invention; and

FIG. 7 depicts a flow chart of a method for transforming a first multimedia data into a second multimedia data according to the present invention.

### DETAILED DESCRIPTION OF THE EMBODIMENTS

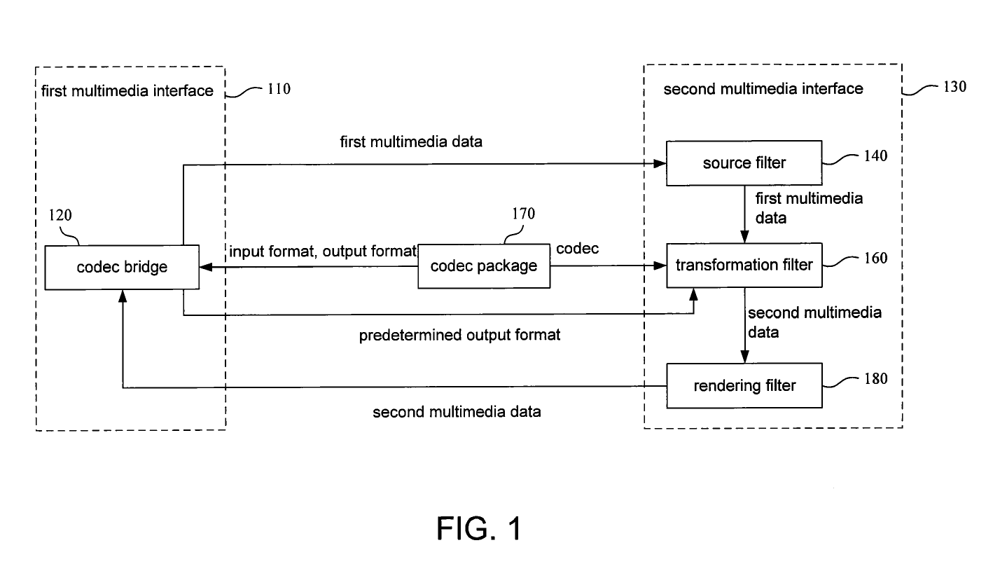

Referring to FIG. 1, which is a block diagram of a multimedia codec device according to a preferred embodiment of the present invention, the multimedia codec device enables multimedia data in a format to be transformed into multimedia data in another format supported by a multimedia interface in the presence of another multimedia interface. The multimedia codec device comprises a codec bridge 120, a source filter 140, a transformation filter 160, and a rendering filter 180. The codec bridge 120 is a plug-in of a first multimedia interface 110. The source filter 140, the transformation filter 160, and the rendering filter 180 are disposed in a second multimedia interface 130. The codec bridge 120 sends a first multimedia data to the second multimedia interface 130. The source filter 140 receives the first multimedia data. The transformation filter 160 transforms the first multimedia data into a second multimedia data according to a codec package 170 compatible with the second multimedia interface 130. The transforming step enables the second multimedia data to be compatible with first multimedia interface 110. The rendering filter 180 outputs the second multimedia data to the codec bridge 120. As a result, the first multimedia interface 110, coupled with the second multimedia interface 130, enables the first multimedia data to be transformed into the second multimedia data compatible with the first multimedia interface 110. For instance, the first multimedia interface 110 can be Java Media Framework (JMF), and the second multimedia interface 130 can be the Directshow developed by Microsoft. Hence, the multimedia codec device of the present invention supports those multimedia file formats which are supported by JMF and Directshow and exhibits advantageous features of JMF and Directshow.

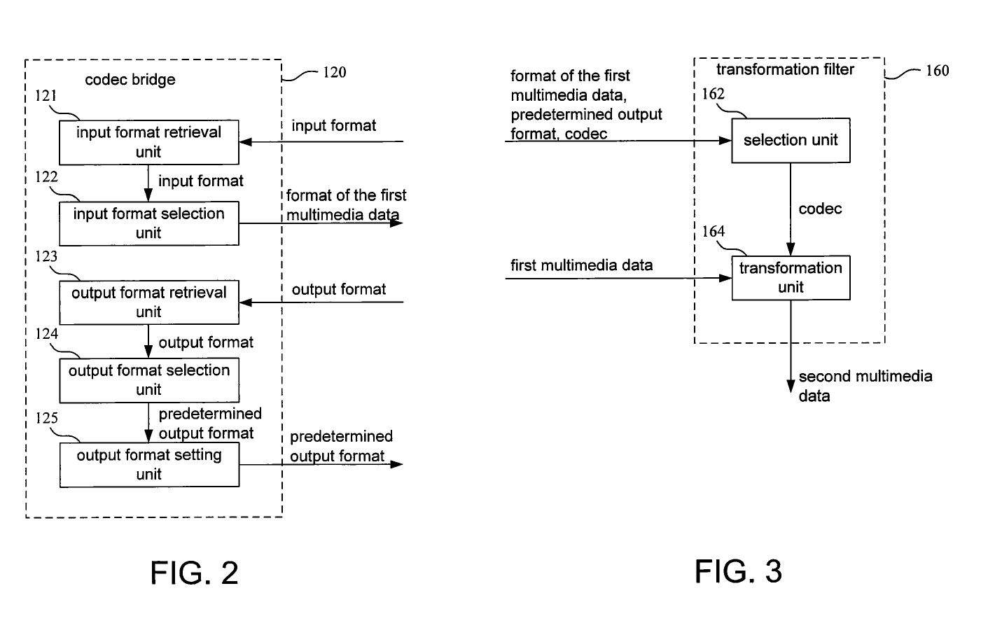

Referring to FIG. 2, which is a block diagram of the codec bridge 120 according to the preferred embodiment of the present invention, the codec bridge 120 comprises an input format retrieval unit 121 and an input format selection unit 122. The input format retrieval unit 121 acquires a plurality of input formats supported by the codec package 170. The input format selection unit 122 reports the input formats to the first multimedia interface 110, and in consequence one of the input formats reported is selected by the first multimedia interface 110 and set as a format of the first multimedia data. Hence, the codec bridge 120 is capable of acquiring the input formats supported by the codec package 170 and setting one of the input formats acquired to a format of the first multimedia data. For instance, the input format retrieval unit 121 acquires input formats supported by the codec package 170, namely avi, mov, wma, mpeg4, and mp3. The input format selection unit 122 reports the input formats avi, mov, wma, mpeg4, and mp3 to the first multimedia interface 110, thereby allowing the first multimedia interface 110 to select one of the input formats and set as a format of the first multimedia data.

Besides, referring to FIG. 2, the codec bridge 120 may comprise an output format retrieval unit 123, an output format selection unit 124, and an output format setting unit 125 as well. The output format retrieval unit 123 acquires a plurality of output formats supported by the codec package 170. The output format selection unit 124 reports the output formats to the first multimedia interface 110, thereby allowing the first multimedia interface 110 to select one of the output formats to be a predetermined output format supported by the first multimedia interface 110. Afterward, the output format setting unit 125 sends the predetermined output format to the transformation filter 160. Hence, the codec bridge 120 is capable of acquiring the output formats supported by the codec package 170 and selecting one of the output formats acquired to be a predetermined output format supported by the first multimedia interface 110. For instance, the output format retrieval unit 123 acquires output formats which are supported by the codec package 170, namely avi, mov, wma, mpeg4, and mp3. The output format selection unit 124 reports the output formats to the first multimedia interface 110, thereby allowing the first multimedia interface 110 to select one of the output formats, namely mpeg4, to be a predetermined output format. Afterward, the output format setting unit 125 sends the predetermined output format mpeg4 to the transformation filter 160.

Referring to FIG. 3, which is a block diagram of a transformation filter 160 according to the preferred embodiment of the present invention, the transformation filter 160 comprises a selection unit 162 and a transformation unit 164. The selection unit 162 selects a codec from the codec package 170 according to a format of the first multimedia data and the predetermined output format. The transformation unit 164 transforms the first multimedia data into the second multimedia data according to the codec. Hence, the transformation filter 160 is capable of transforming the first multimedia data into the second multimedia data supported by the first multimedia interface 110. For instance, given avi as the format of the first multimedia data and mpeg4 as the predetermined output format, the selection unit 162 selects, from the codec package 170, a codec for converting avi to mpeg4, and then the transformation unit 164 transforms the first multimedia data in avi format into the second multimedia data in mpeg4 format according to the codec.

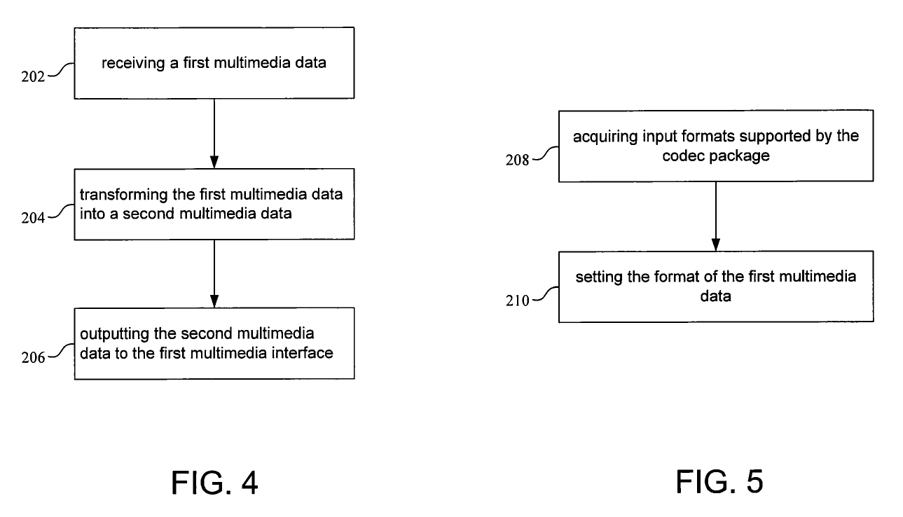

Referring to FIG. 4, which is a flow chart of a multimedia codec method according to another preferred embodiment of the present invention, the multimedia codec method comprises transforming multimedia data in a format into multimedia data in another format supported by a multimedia interface in the presence of another multimedia interface. Unless otherwise specified, the sequence of the steps described in the preferred embodiments of the present invention is subject to change as needed, wherein the change includes concurrence occurring in whole or in part, and a change in precedence. Referring to FIG. 4 again, the multimedia codec method comprises the steps of:

(1) receiving a first multimedia data from a first multimedia interface to a second multimedia interface; (Step 202)

(2) transforming the first multimedia data into a second multimedia data according to a codec package compatible with the second multimedia interface, so as to allow the second multimedia data to be compatible with the first multimedia interface; (Step 204)

(3) outputting the second multimedia data to the first multimedia interface. (Step 206)

Hence, with the second multimedia interface, the first multimedia data is transformed into the second multimedia data supported by the first multimedia interface. For instance, the first multimedia interface can be Java Media Framework (JMF), and the second multimedia interface can be the Directshow developed by Microsoft. Hence, the multimedia codec method of the present invention supports those multimedia file formats which are supported by JMF and Directshow and exhibits advantageous features of JMF and Directshow.

Furthermore, the multimedia codec method may further comprise a method whereby input formats are acquired so as to set a format of the first multimedia data. Referring to FIG. 5, which is a flow chart of a method for acquiring an input format according to the present invention, the method comprises the steps of:

(4) acquiring from the second multimedia interface a plurality of input formats supported by the codec package; (Step 208)

(5) reporting the input formats to the first multimedia interface, wherein one of the input formats reported is selected by the first multimedia interface and set as a format of the first multimedia data. (Step 210)

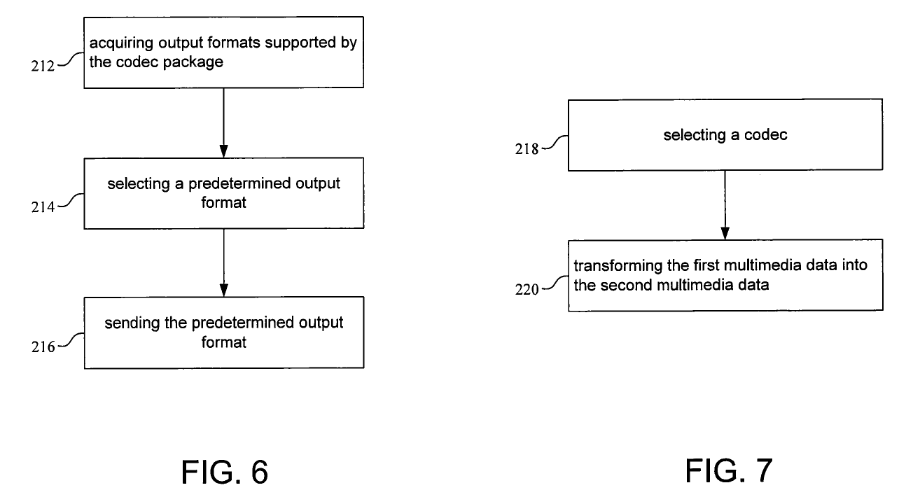

Besides, the multimedia codec method may comprise a method for acquiring an output format as well. Referring to FIG. 6, which is a flow chart of a method for acquiring an output format according to the present invention, the method comprises the steps of:

(6) acquiring a plurality of output formats supported by the codec package; (Step 212)

(7) reporting the output formats to the first multimedia interface, wherein one of the output formats reported is selected by the first multimedia interface to be supported by the first multimedia interface and to be a predetermined output format; (Step 214)

(8) sending the predetermined output format. (Step 216)

Hence, the supported output formats are acquired, and then one of the output formats acquired is selected to be a predetermined output format.

Referring to FIG. 7, which is a flow chart of a method for transforming a first multimedia data into a second multimedia data according to the present invention, the method comprises the steps of:

(2.1) selecting a codec from the codec package according to a format of the first multimedia data and the predetermined output format; (Step 218)

(2.2) transforming the first multimedia data into the second multimedia data according to the codec. (Step 220)

Hence, the first multimedia data is transformed into the second multimedia data supported by the first multimedia interface according to the predetermined output format.

As revealed by the aforesaid preferred embodiments of the present invention, the present invention has the following advantages. A multimedia interface's capacity to process multimedia is expanded by a codec package of another multimedia interface. Hence, a developer of the former multimedia interface can process otherwise unsupported multimedia data without writing a program otherwise, instead of being restricted from the former multimedia interface's capacity to process multimedia data.

Although the present invention has been disclosed by the foregoing preferred embodiments, the embodiments are not intended to restrict the scope of the present invention. It will be understood by persons skilled in the art that various changes and modifications apparent thereto may be effected in the foregoing preferred embodiments without departing from the spirit and scope of the invention as defined by the appended claims. Hence, the scope of the present invention should be defined by the appended claims.

What is claimed is:

1. A multimedia codec device comprising:
a codec bridge is a plug-in of a first multimedia interface and configured to send a first multimedia data to a second multimedia interface;
a source filter disposed in the second multimedia interface and configured to receive the first multimedia data;
a transformation filter disposed in the second multimedia interface and configured to transform the first multimedia data to a second multimedia data according to a codec package compatible with the second multimedia interface, allowing the second multimedia data to be compatible with the first multimedia interface; and
a rendering filter disposed in the second multimedia interface and configured to output the second multimedia data to the codec bridge.

2. The multimedia codec device of claim 1, wherein the codec bridge comprises:
an input format retrieval unit for acquiring a plurality of input formats supported by the codec package; and
an input format selection unit for reporting the input formats to the first multimedia interface, wherein one of the input formats reported is selected by the first multimedia interface and set as a format of the first multimedia data.

3. The multimedia codec device of claim 1, wherein the codec bridge comprises:
an output format retrieval unit for acquiring a plurality of output formats supported by the codec package;
an output format selection unit for reporting the output formats to the first multimedia interface, wherein one of the output formats reported is selected by the first multimedia interface to be supported by the first multimedia interface and to be a predetermined output format; and
an output format setting unit for sending the predetermined output format to the transformation filter.

4. The multimedia codec device of claim 3, wherein the transformation filter comprises:
a selection unit for selecting a codec from the codec package according to a format of the first multimedia data and the predetermined output format; and
a transformation unit for transforming the first multimedia data into the second multimedia data according to the codec.

5. A multimedia codec method comprising the steps of:
receiving a first multimedia data from a first multimedia interface to a second multimedia interface;
transforming the first multimedia data into a second multimedia data according to a codec package compatible with the second multimedia interface, so as to allow the second multimedia data to be compatible with the first multimedia interface; and
outputting the second multimedia data to the first multimedia interface.

6. The multimedia codec method of claim 5, further comprising the steps of:
acquiring from the second multimedia interface a plurality of input formats supported by the codec package; and
reporting the input formats to the first multimedia interface, wherein one of the input formats reported is selected by the first multimedia interface and set as a format of the first multimedia data.

7. The multimedia codec method of claim 5, further comprising the steps of:
acquiring a plurality of output formats supported by the codec package;
reporting the output formats to the first multimedia interface, wherein one of the output formats reported is selected by the first multimedia interface to be supported by the first multimedia interface and to be a predetermined output format; and
sending the predetermined output format.

8. The multimedia codec method of claim 7, wherein the transforming the first multimedia data into the second multimedia data comprises the steps of:
selecting a codec from the codec package according to a format of the first multimedia data and the predetermined output format; and
transforming the first multimedia data into the second multimedia data according to the codec.
